(19) United States
(12) Patent Application Publication
(10) Pub. No.: US 2025/0344288 A1
(43) Pub. Date: Nov. 6, 2025

(54) MULTICAST SESSION MANAGEMENT

(71) Applicant: Telefonaktiebolaget LM Ericsson (publ), Stockholm (SE)

(72) Inventors: Yumei Song, Göteborg (SE); Mikael Wass, Sätila (SE); Jie Ling, Shanghai (CN)

(21) Appl. No.: 18/724,054

(22) PCT Filed: Jan. 2, 2023
(86) PCT No.: PCT/EP2023/050004

§ 371 Date: Jun. 25, 2024

(30) Foreign Application Priority Data
Jan. 4, 2022 (WO) PCT/CN2022/070098

(51) Int. Cl. H04W 76/40; H04W 76/20; H04W 76/30

(52) U.S. Cl. CPC H04W 76/40; H04W 76/20; H04W 76/30

(57) ABSTRACT

A network node, a UE, and methods for managing a multicast session for the UE. The method comprises: receiving, from an MB-SMF, a first message indicating that the multicast session is released; and transmitting, to the UE, a first indication indicating that the multicast session is released.

### CROSS-REFERENCE TO RELATED APPLICATION(S)

This application claims priority to the PCT International Application No. PCT/CN2022/070098, entitled “MULTICAST SESSION MANAGEMENT”, filed on Jan. 4, 2022, which is incorporated herein by reference in its entirety.

### TECHNICAL FIELD

The present disclosure is related to the field of telecommunications, and in particular, to network nodes, user equipments (UEs), and methods for multicast session management.

### BACKGROUND

Broadcast services, with a scheduled programming, constitute a paramount telecommunication service for today's society. Broadcast is a transport technology to deliver the same content to an unlimited number of devices with a defined quality of service, without increasing substantially network capacity requirements, energy consumption, or costs. Cellular systems are commonly used for unicast transmissions. In this mode, a dedicated channel is established with each UE. In scenarios with a large number of users or devices consuming the same data, the use of broadcast or multicast transmission can offer substantial capacity gains, ensuring a cost-effective and high-quality delivery mechanism.

At unicast transmission, required radio resources grow linearly with the number of UEs receiving the same data. Resource allocation efficiency is improved by simultaneous transmission of data to a set of users. Via broadcast services, all users receive the same information within the service area. In multicast services, users have to subscribe to the specific service before they can receive the information. While broadcast communication is unidirectional, multicast users can establish a return channel allowing interactivity with the network. This return channel can also be used to subscribe to the desired service.

Although the existing technology is mature, current broadcast systems have serious limitations when providing service to moving users or users located in areas with complex orography and poor signal quality. To overcome these limitations, 3rd Generation Partnership Project (3GPP) 5G standard has included a work item to support 5G multicast/broadcast services for Release 17. This will bring the wide flexibility and efficiency of 5G networks to broadcasting services to greatly improve user experience while reducing operational costs. In addition, 5G broadcast/multicast services can complement conventional broadcasting technology which has severe deficiencies in some scenarios like mobility or users in remote areas.

### SUMMARY

According to a first aspect of the present disclosure, a method at a Session Management Function (SMF) for managing a multicast session for a UE is provided. The method comprises: receiving, from a Multicast/Broadcast Session Management Function (MB-SMF), a first message indicating that the multicast session is released; and transmitting, to the UE, a first indication indicating that the multicast session is released, wherein the first indication comprises one or more bits for rejection cause which indicates the reason of removing the UE from the multicast session.

In some embodiments, the method further comprises: deciding to remove the UE from the multicast session. In some embodiments, the first indication is transmitted to the UE via an Access and Mobility management Function (AMF) and a Radio Access Network (RAN) node that serve the UE. In some embodiments, before the step of transmitting, to the UE, the first indication, the method further comprises: determining whether the UE has an activated User Plane (UP) or not. In some embodiments, before the step of receiving, from the MB-SMF, the first message, the method further comprises: transmitting, to the MB-SMF, a second message for subscribing a session context of the multicast session. In some embodiments, the method further comprises: receiving, from the AMF, a third message indicating that the UE is currently aware of the release of the multicast session. In some embodiments, at least one of following is true: the first message is an Nmbsmf_MBSSession_ContextStatusNotify message; the second message is an Nmbsmf_MBSSession_ContextStatusSubscribe request message; and the third message is an Nsmf_PDUSession_UpdateSMContext request message; and the first indication is an N1 Session Management (SM) container that is carried by an Namf_Communication_N1N2MessageTransfer message from the SMF to the AMF, by an N2 Request message from the AMF to the RAN node, and by a Protocol Data Unit (PDU) Session Modification Command encapsulated in a Radio Resource Control (RRC) message from the RAN node to the UE.

According to a second aspect of the present disclosure, a first network node is provided. The first network node comprises: a processor; a memory storing instructions which, when executed by the processor, cause the processor to perform the method of any of the first aspect. In some embodiments, the first network node comprises an SMF.

According to a third aspect of the present disclosure, a method at a UE for managing a multicast session is provided. The method comprises: receiving, from an SMF, a first indication indicating that the multicast session is released, wherein the first indication comprises one or more bits for rejection cause which indicates the reason of removing the UE from the multicast session.

In some embodiments, the first indication is received from the SMF via an AMF and a RAN node that serve the UE. In some embodiments, the method further comprises: transmitting, to the RAN node, a fourth message indicating that the UE is currently aware of the release of the multicast session. In some embodiments, at least one of following is true: the fourth message is a PDU Session Modification Acknowledgement message; and the first indication is an N1 Session Management (SM) container that is carried by an Namf_Communication_N1N2MessageTransfer message from the SMF to the AMF, by an N2 Request message from the AMF to the RAN node, and by a PDU Session Modification Command encapsulated in an RRC message from the RAN node to the UE.

According to a fourth aspect of the present disclosure, a UE is provided. The UE comprises: a processor; a memory storing instructions which, when executed by the processor, cause the processor to perform the method of any of the third aspect.

According to a fifth aspect of the present disclosure, a computer program including instructions is provided. The instructions, when executed by at least one processor, cause the at least one processor to carry out any of the methods of any of the first and third aspects.

According to a sixth aspect of the present disclosure, a carrier containing the computer program of the fifth aspect is provided. In some embodiments, the carrier is one of an electronic signal, optical signal, radio signal, or computer readable storage medium.

According to a seventh aspect of the present disclosure, a telecommunication system for managing a multicast session is provided. The telecommunication system comprises: one or more UEs of the fourth aspect; and a first network node of the second aspect.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunication network in which multicast session management according to an embodiment of the present disclosure may be applicable.

FIG. 2A and FIG. 2B are diagrams illustrating an exemplary procedure for managing a multicast session according to an embodiment of the present disclosure.

FIG. 3 is a diagram illustrating another exemplary procedure for managing a multicast session according to an embodiment of the present disclosure.

FIG. 4 is a diagram illustrating an exemplary procedure for network-requested PDU session modification with which multicast session management according to an embodiment of the present disclosure may be applicable.

FIG. 5A and FIG. 5B are diagrams illustrating exemplary information elements (IEs) which may be applicable for multicast session management according to an embodiment of the present disclosure.

FIG. 6 is a flow chart of an exemplary method at an SMF for managing a multicast session for a UE according to an embodiment of the present disclosure.

FIG. 7 is a flow chart of an exemplary method at a UE for managing a multicast session according to an embodiment of the present disclosure.

FIG. 8 schematically shows an embodiment of an arrangement which may be used in a network node and/or a UE according to an embodiment of the present disclosure.

FIG. 9 is a block diagram of an exemplary first network node according to an embodiment of the present disclosure.

FIG. 10 is a block diagram of an exemplary UE according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (5G NR), the present disclosure is not limited thereto. In fact, as long as multicast session management is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “network node” used herein may refer to or comprise a base station, a base transceiver station, an access point, a hot spot, a NodeB (NB), an evolved NodeB (eNB), a gNB, a network element, a network function, or any other equivalents.

Further, following 3GPP documents are incorporated herein by reference in their entireties:
3GPP TS 23.247 V17.0.0 (2021-09), 3rd Generation Partnership Project; Technical Specification Group Services and System Aspects; Architectural enhancements for 5G multicast-broadcast services; Stage 2 (Release 17);
3GPP TS 24.501 V17.4.1 (2021-09), 3rd Generation Partnership Project; Technical Specification Group Core Network and Terminals; Non-Access-Stratum (NAS) protocol for 5G System (5GS); Stage 3; (Release 17).

MBS is a point-to-multipoint service offered by 3GPP 5G NR, in which data is transmitted from a single source entity to multiple recipients, either to all users in a broadcast service area, or to users in a multicast group. The corresponding types of MBS session are:
Broadcast session;
Multicast session.

The MBS architecture defined in clause 5 of TS 23.247 follows the 5G System (5GS) architectural principles as defined in TS 23.501, enabling distribution of the MBS data from the 5GS ingress to NG-RAN node(s) and then to the UE. The MBS architecture provides:
Efficient usage of RAN and Core Network (CN) resources, with an emphasis on radio interface efficiency;
Efficient transport for a variety of multicast and broadcast services.

MBS traffic is delivered from a single data source (e.g. Application Service Provider) to multiple UEs. Depending on many factors, there are several delivery methods which may be used to deliver the MBS traffic in the 5GS.

Please note that, for clarity, delivery methods are not referred to as unicast/multicast/broadcast but as described below. The term “unicast delivery” refers to a mechanism by which application data and signaling between the UE and the application server are delivered using PDU Session within the 3GPP network and using individual UE and application server addresses (e.g. IP addresses) between the 3GPP network and the application server. It is not equivalent to 5G Core (5GC) Individual MBS traffic delivery method defined here.

Between 5GC and NG-RAN, there are two possible delivery methods to transmit the MBS data:
5GC Individual MBS traffic delivery method: This method is only applied for multicast MBS session. 5GC receives a single copy of MBS data packets and delivers separate copies of those MBS data packets to individual UEs via per-UE PDU sessions, hence for each such UE one PDU session is required to be associated with a multicast session.
5GC Shared MBS traffic delivery method: This method is applied for both broadcast and multicast MBS session. 5GC receives a single copy of MBS data packets and delivers a single copy of those MBS packets to an NG-RAN node, which then delivers the packets to one or multiple UEs.

However, the present disclosure is not limited thereto. In some other embodiments, other delivery methods between 5GC and NG-RAN nodes may also be applicable.

The 5GC Shared MBS traffic delivery method is required in all 5G MBS deployments. The 5GC Individual MBS traffic delivery method is required to enable mobility when there is an NG-RAN deployment with non-homogeneous support of 5G MBS.

For the multicast session, a single copy of MBS data packets received by the CN may be delivered via 5GC Individual MBS traffic delivery method for some UE(s) and via 5GC Shared MBS traffic delivery method for other UES.

Between the NG-RAN and the UE, two delivery methods are available for the transmission of MBS data packets over radio interface:
Point-to-Point (PTP) delivery method: NG-RAN delivers separate copies of MBS data packets over radio interface to individual UE(s).
Point-to-Multipoint (PTM) delivery method: NG-RAN delivers a single copy of MBS data packets over radio interface to multiple UEs.

However, the present disclosure is not limited thereto. In some other embodiments, other delivery methods between NG-RAN and UEs may also be applicable.

NG-RAN may use a combination of PTP/PTM to deliver MBS data packets to UEs. For MBS multicast communication, if the NG-RAN node supports 5G MBS, the network may use the 5GC Shared MBS traffic delivery method for MBS data transmission.

For MBS multicast communication, the switching between 5GC Shared MBS traffic delivery method and 5GC Individual MBS traffic delivery method may be supported. The UE mobility between RAN nodes both supporting MBS, and between a RAN node supporting MBS and a RAN node not supporting MBS may be supported.

For MBS multicast communication, the switching between PTP and PTM delivery methods for 5GC Shared MBS traffic delivery may be supported. NG-RAN may be the decision point for switching between PTP and PTM delivery methods.

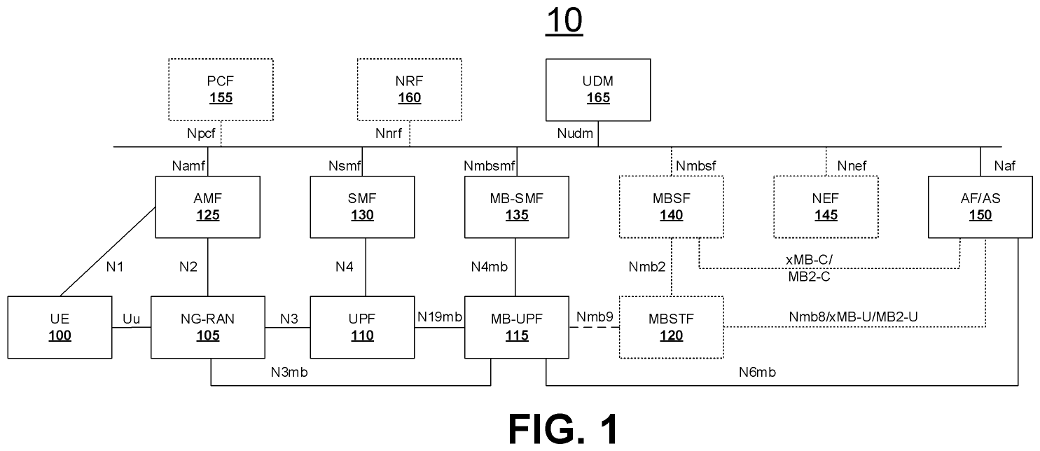

FIG. 1 is a diagram illustrating an exemplary telecommunication network 10 in which multicast session management according to an embodiment of the present disclosure may be applicable. Although the telecommunications network 10 is a network defined in the context of 5G NR, the present disclosure is not limited thereto.

As shown in FIG. 1, the network 10 may comprise one or more UEs 100 and an NG-RAN 105, which could be or comprise one or more of base station, a Node B, an evolved NodeB (eNB), a gNB, or an access network (AN) node which provides the UEs 100 with access to other parts of the network 10. Further, the network 10 may comprise its core network portion comprising (but not limited to) an AMF 125, an SMF 130, a User Plane Functions (UPF) 110, a Policy Control Function (PCF) 155, a Network Exposure Function (NEF) 145, an Application Function/Application Server (AF/AS) 150, a Unified Data Management (UDM) 165, and/or a Network Repository Function (NRF) 160. Further, in addition to these network functions, the telecommunication network 10 may further comprise network functions for supporting MBS, comprising (but not limited to) an MB-SMF 135, an MB-UPF 115, a Multicast/Broadcast Service Function (MBSF) 140, and a Multicast/Broadcast Service Transport Function (MBSTF) 120. As shown in FIG. 1, these entities may communicate with each other via the service-based interfaces, such as, Namf, Nsmf, Npcf, etc. and/or the reference points, such as, N1, N2, N3, N4, N4mb, etc.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions (e.g., mobility management entity (MME)) may be different from those shown in FIG. 1 (e.g., the AMF 125). For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure. The functions shown in FIG. 1 will be described in detail below.

Referring to FIG. 1, the AMF 125 may provide most of the functions that the MME provides in a 4G network as mentioned above. Below please find a brief list of some of its functions:
Terminates the RAN Control Plane (CP) interface (N2);
Non-access stratum (NAS) signaling;
NAS ciphering and integrity protection;
Mobility Management (MM) layer NAS termination;
Session Management (SM) layer NAS forwarding;
Authenticates UE 100;
Manages the security context;
Registration management;
Connection management;
Reachability management;
Mobility Management; and/or
Apply mobility related policies from PCF 155 (e.g., mobility restrictions).

In addition to the functions defined above, the AMF 125 may further perform at least one of following functions to support MBS:
Signaling with NG-RAN 105 and MB-SMF 135 for MBS Session management;
Selection of NG-RANS 105 for notification of multicast session activation toward UEs 100 in CM-IDLE state;
Selection of NG-RANs 105 for broadcast traffic distribution.

Additionally, the AMF 125 may be aware of NG-RAN 5G MBS capability.

The SMF 130 may provide the session management functions that are handled by the 4G MME, Secure Gateway-Control plane (SGW-C), and PDN Gateway-Control plane (PGW-C). Below please find a brief list of some of its functions:
Allocates IP addresses to UEs;
NAS signaling for session management (SM);
Sends Quality of Service (QOS) and policy information to the NG-RAN 105 via the AMF 125;
Downlink data notification;
Select and control the UPF 110 for traffic routing;
Acts as the interface for all communication related to offered user plane services; and/or
Lawful intercept-control plane.

In addition to the functions defined above, the SMF 130 may further perform at least one of following functions to support MBS:
Discovering MB-SMF 135 for a multicast session;
Authorizing multicast session join operation if needed;
Interacting with MB-SMF 135 to obtain and manage multicast session context; and
Interacting with RAN 105 for shared data transmission resource establishment.

Please note that the SMF 130 and the MB-SMF 135 may be co-located or deployed separately.

Further, the UPFs 110 is essentially a fusion of the data plane parts of the SGW and PGW. In the context of the Control User Plane Separation (CUPS) architecture: Evolved Packet Core (EPC) SGW-U+EPC PGW-U→5G UPF.

The UPFs 110 may perform at least one of following functions:
Packet routing and forwarding
Packet inspection and QoS handling, and the UPF 110 may optionally integrate a Deep Packet Inspection (DPI) for packet inspection and classification;
Connecting to the Internet POP (Point of Presence), and the UPF 110 may optionally integrate the Firewall and Network Address Translation (NAT) functions;
Mobility anchor for Intra RAT and Inter-RAT handovers;
Lawful intercept-user plane; and
Maintains and reports traffic statistics.

In addition to the functions defined above, the UPF 110 may further perform at least one of following functions to support MBS:
Interacting with SMF 130 for receiving multicast data from MB-UPF 115 for 5GC Individual MBS traffic delivery method;
Delivering multicast data to UEs 100 via PDU Session for 5GC Individual MBS traffic delivery method.

Please note that the UPF 110 and MB-UPF 115 may be co-located or deployed separately.

In addition to the functions defined in TS 23.501, the PCF 155 may perform at least one of the following functions to support MBS if dynamic PCC for 5MBS is needed:
Supporting QoS handling for MBS Session;
Providing policy information regarding the MBS Session to MB-SMF 135 for authorizing the related QoS profiles;
Interacting with UDR for QoS information retrieval; and
The PCF 155 can receive MBS information from AF 150, NEF 145 or MBSF 140, e.g. based on the different configuration options.

The MB-SMF 135 may perform at least one of the following functions to support MBS:
General for multicast and broadcast sessions:
   Supporting MBS session management (including QoS control);
   Configuring the MB-UPF 115 for multicast and broadcast flows transport based on the policy rules for multicast and broadcast services from PCF 155 or local policy;
   Allocating and de-allocating Temporary Mobile Group Identity (TMGI);
Specific for broadcast sessions:
   Interacting with RAN 105 (via AMF 125) to control data transport using 5GC Shared MBS traffic delivery method;
Specific for multicast sessions:
   Interacting with SMF 130 to modify PDU Session associated with MBS session;
   Interacting with RAN 105 (via AMF 125 and SMF 130) to establish data transmission resources between MB-UPF 115 and RAN nodes for 5GC Shared MBS traffic delivery method;
   Controlling multicast data transport using 5GC Individual MBS traffic delivery method.

The MB-UPF 115 may perform at least one of the following functions to support MBS:
General for multicast and broadcast sessions:
   Packet filtering of incoming downlink packets for multicast and broadcast flows;
   QoS enforcement (Maximum Flow Bit Rate (MFBR)) and counting/reporting based on existing means;
   Interaction with MB-SMF 135 for receiving multicast and broadcast data;
   Delivery of multicast and broadcast data to RAN nodes 105 for 5GC Shared MBS traffic delivery method;
Specific for multicast sessions:
   Delivery of multicast data to UPF 110 for 5GC Individual MBS traffic delivery method.

In addition to the functions defined in TS 23.501, the NG-RAN 105 may perform at least one of the following functions to support MBS:
Management of MBS QoS flows via N2;
Delivery of MBS data packets from 5GC shared for multiple UEs 100 over radio using PTM or PTP;
Configuration of UE 100 for MBS QoS flow reception at AS layer;
Control switching between PTM and PTP delivery per UE;
Support for multicast sessions continuity during Xn Handover and N2 Handover;
Support notification of multicast session activation over radio toward UEs 100 in CM-IDLE state and CM-CONNECTED with RRC Inactive state.

In addition to the functions defined in TS 23.501, the UE 100 may perform at least one of the following functions to support MBS:
Reception of multicast data using PTM/PTP;
Reception of broadcast data using PTM;
Handling of incoming MBS QoS flows;
Support of signaling for joining and leaving multicast MBS session;
MBS resource management support at AS layer; and
Reception of notification in CM-IDLE state and CM-CONNECTED with RRC Inactive state for multicast data transmission.

The AF 150 may perform at least one of the following functions to support MBS:
Requesting multicast or broadcast service from the 5GC by providing service information including QoS requirement to 5GC;
Instructing MBS session operation towards 5GC if needed; and
Interacting with NEF 145 for MBS related service exposure.

In addition to the functions defined in TS 23.501, the NEF 145 may further perform at least one of the following functions to support MBS:
Providing an interface to AFs 150 for MBS procedures including service provisioning, MBS session and QoS management;
Interacting with AF 150 and NFs in 5GC, e.g., MB-SMF 135 for MBS session operations, determination of transport parameters; and
Selection of MB-SMF 135 to serve an MBS Session.

The MBSF 140 may perform at least one of the following functions to support MBS:
Service level functionality to support MBS, and interworking with LTE MBMS;
Interacting with AF 150 and MB-SMF 135 for MBS session operations, determination of transport parameters, and session transport;
Selection of MB-SMF 135 to serve an MBS Session;
Controlling MBSTF 120 if the MBSTF 120 is used; and
Determination of sender IP multicast address for the MBS session if IP multicast address is sourced by MBSTF 120.

The MBSTF 120 may perform at least one of the following functions to support MBS if deployed:
Media anchor for MBS data traffic if needed;
Sourcing of IP Multicast if needed;
Generic packet transport functionalities available to any IP multicast enabled application such as framing, multiple flows, packet FEC (encoding); and
Multicast/broadcast delivery of input files as objects or object flows.

In addition to the functions defined in TS 23.501, the UDM 165 may further perform at least one of the following functions to support MBS:
Support management of subscription for authorization for multicast MBS sessions.

In addition to the functions defined in TS 23.501, the UDR may perform at least one of the following functions to support MBS if deployed:
Support management of UE authorization information for multicast MBS session; and
Support management of policy information for multicast or broadcast MBS session.

In addition to the functions defined in TS 23.501, the NRF 160 may further perform at least one of the following functions to support 5G MBS:
Support of new NF types MB-SMF and MBSF and their corresponding NF profiles;
For both multicast and broadcast MBS Session, support of MB-SMF discovery based on parameters such as Data Network Name (DNN), Single-Network Slice Selection Assistance Information (S-NSSAI) and MB service area, at MBS Session creation; and
For multicast MBS Session, support of MB-SMF discovery based on MBS Session ID by SMF 130 serving the multicast Session at UE join.

Please note that the MBSF 140 is optional and may be collocated with the NEF 145 or AF/AS 150, and the MBSTF 120 may be an optional network function. Further, the existing service based interfaces of Nnrf, Nudm, and Nsmf may be enhanced to support 5G MBS. The existing service based interfaces of Npcf and Nnef may be enhanced to support 5G MBS. The interfaces xMB-C/MB2-C and xMB-U/MB2-U may be intended for legacy AS. A 5G MBS enabled AF may use either Nmbsf or Nnef to interact with the MBSF. Further, the existing reference points of N1, N2, N4, N10, N11, N30, and N33 may be enhanced to support 5G MBS.

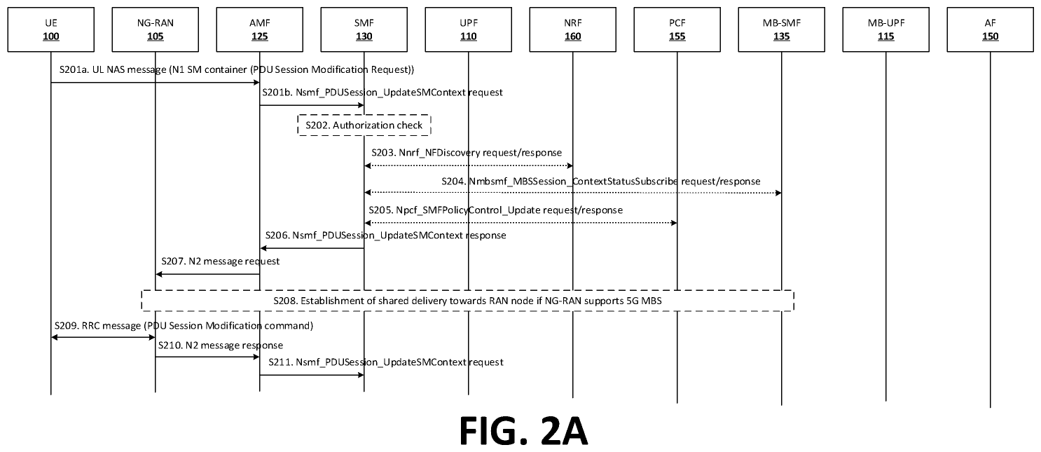

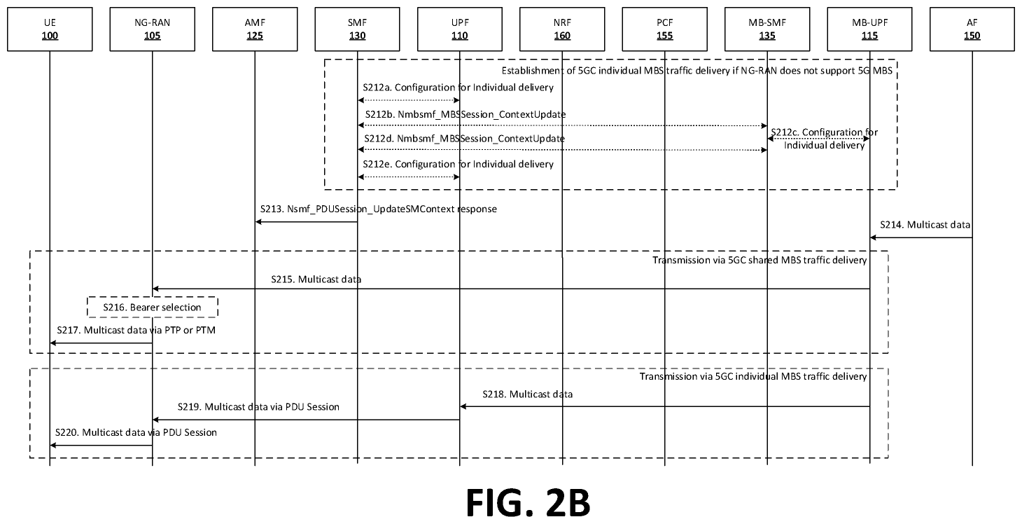

FIG. 2A and FIG. 2B are diagrams illustrating an exemplary procedure for managing a multicast session according to an embodiment of the present disclosure. Although multiple steps S201a through S220 are shown by FIG. 2A and FIG. 2B, the present disclosure is not limited thereto. In some other embodiments, the procedure may comprise more operations, less operations, different operations, or any combination thereof. Further the operations of the procedure may be performed in a different order than that described herein. Further, in some embodiments, an operation in the procedure may be split into multiple sub-operations and performed by different entities, and/or multiple operations in the procedure may be combined into a single operation.

Further, the following steps may be executed before the UE 100 requests to join the MBS session:
The MBS Session may have been configured in the 5GC;
The UE 100 may register in the PLMN and establishes a PDU session; and
The UE 100 may have known at least the MBS Session ID of a multicast group that the UE 100 can join, e.g. via service announcement.

To join the multicast group, the UE 100 may send, to the SMF 130 via the AMF 125, a PDU Session Modification Request which additionally contains one or several MBS Session ID(s) and join request, at steps S201a and S201b shown in FIG. 2A. In some embodiments, the MBS Session ID(s) may indicate the multicast group(s) that UE 100 wants to join.

At an optional step S202, based on the received MBS Session ID and join request, the SMF 130 may determine that this is MBS Session join request. The SMF 130 may check whether the user (or the UE 100) is authorized to use the required multicast service.

At an optional step S203, if the SMF 130 has no information about MBS Session context for the indicated MBS Session ID(s), the SMF 130 may discover and select an MB-SMF (e.g., the MB-SMF 135) for the MBS Session via the NRF 160. If no MB-SMF is assigned for the MBS session ID, the SMF 130 may select an MB-SMF (e.g., the MB-SMF 135) and request it configure the multicast session or the SMF 130 may reject the join request.

At an optional step S204, an Nmbsmf_MBSSession_ContextStatusSubscribe request transmitted from the SMF 130 to the MB-SMF 135 indicates that the SMF 130 wants to subscribe the MBS session context. For each MBS session in step S201a/S201b, by using Nmbsmf_MBSSession_ContextStatusSubscribe request (MBS Session ID) with the immediately reporting flag, the SMF 130 may interact with the MB-SMF 135 to retrieve information about the indicated multicast session context information (multicast QOS flow information (e.g., QoS profile(s) for multicast MBS session), [start time], [session status indication (active/inactive)], [MBS session authorization information (MBS session open for any user)], LL MC address]) and to subscribe to events notifications related to the multicast session.

If it is the first time for the MB-SMF 130 to receive Nmbsmf_MBSSession_ContextStatusSubscribe request of the indicated MBS Session from SMF 130, MB-SMF 135 may learn that it is the first UE joining the multicast group. For multicast transport between MB-UPF 115 and content provider, if it is the first UE joining the multicast group, and MB-UPF 115 has not joined the multicast tree in the MBS configuration procedure, the MB-SMF 135 may requests the MB-UPF 115 to join the multicast tree towards the AF 150/MBSF 140, otherwise MB-SMF 135 will not send the request to the MB-UPF 115. The MB-SMF 135 may determine whether the user is authorized to join the multicast session as follows: The MB-SMF 135 may check the user subscription data received from the UDM 165 to determine whether the user is allowed to use any multicast service. If so, the MB-SMF 135 may check the received indication whether the multicast session is open for any user. If the multicast session is not open to any user, the MB-SMF 135 may check the user subscription data received from the UDM 165 to determine whether the MBS session ID is included. If a UE joins prior to the start time of the multicast session, the SMF 130 may accept the join request in step S207 and indicate to the UE 100 the start time, or it may reject the join request with appropriate error cause and possible back-off time. If a UE joins while the multicast session is inactive, the SMF 130 may accept the join request in step S207. If authorization check fails, the SMF 130 may indicate cause value in the PDU Session Modification Reject sent to the UE and proceeds with step S207.

Please note that the MB-SMF 135 can answer the Nmbsmf MBSSession_ContextStatusSubscribe request either based on information received in the configuration procedures in Clause 7.1.1 of TS 23.247 or based on preconfigured information. The pre-configuration may also include information about the MBS session stored in the NRF 160. If the MB-SMF 135 uses preconfigured information, the pre-configuration may also include MB-UPF configuration.

At step S206, SMF 130 may respond to AMF through Nsmf_PDUSession_UpdateSMContext response (N2 SM information (PDU Session ID, MBS Session ID, [updated PDU Session information], [mapping information between unicast QOS flow(s) and multicast QoS flow(s)]), N1 SM container (PDU Session Modification Command)) to:
create an MBS session context for the indicated MBS session in the RAN 105, if it does not exist in the RAN 105 already; and
inform the NG-RAN 105 about the relation between the multicast context and the UE 100's PDU Session context by including the MBS session ID and the mapping between the multicast QoS flow(s) and associated QoS flow(s).

Based on operator policy, the SMF 130 may prepare for 5GC individual MBS traffic delivery fallback. The SMF 130 may map the received QoS information of the multicast QoS Flow into PDU Session's unicast QoS Flow information, and include the information of the QoS Flows and the mapping information about the QoS Flows in the SM information sent to RAN 105.

Please note that, a PDU Session UP activation is not triggered by step S206 if it only includes information related to the multicast session and associated QoS flows and is received by an MBS capable NG RAN node.

At step S207, the N2 message, which may include the multicast session information and PDU session modification information, may be sent to the NG-RAN 105.

If the 5G MBS is not supported by NG-RAN 105, 5GC individual MBS traffic delivery may be used. Otherwise if the MBS is supported by NG-RAN 105, 5GC shared MBS traffic delivery may be adopted.

If the NG-RAN 105 supports 5G MBS, the NG-RAN 105 may use the MBS Session ID to determine that the PDU Session identified by the PDU Session ID is associated with the indicated multicast session.

If the multicast QoS information is received and the NG-RAN 105 supports MBS, the associated unicast QoS flow information is not used to allocate the radio resource and CN resource.

Please note that it is NG-RAN 105 that decides whether radio resource is allocated or not, and it is NG-RAN 105/UPF 110 that decides whether multicast transport or unicast transport is used between the NG-RAN 105/UPF 110 and the MB-UPF 115.

At an optional step S208, if shared tunnel has not been established for the MBS session towards the NG-RAN node 105, the procedures in clause 7.2.1.4 of TS 23.247 for the Establishment of shared delivery toward RAN node may be executed. Step S208 may be executed separately for each MBS session.

At step S209, the NG-RAN node 105 may perform AN specific signaling exchange with the UE 100 to establish radio resource for the MBS session if not established yet. If the NG-RAN 105 does not support MBS, radio resource may be reconfigured for unicast transmission of the MBS data over the associated PDU session. As part of the AN specific signaling exchange, the N1 SM container (PDU Session Modification Command) may be provided to the UE 100.

At step S210, the NG-RAN node 105 may send the PDU session modification response.

If the MBS is not supported by NG-RAN 105, the accepted unicast QoS flow may be included in the N2 SM response container. If the MBS is supported by NG-RAN 105, the N2 SM response container may include the accepted multicast QoS flow.

At step S211, the AMF 125 may invoke Nsmf_PDUSession_UpdateSMContext request ([N2 SM container]) to the SMF 130.

Per the accepted unicast QoS flow information, the SMF 130 may determine the delivery mode, i.e. whether 5GC individual MBS traffic delivery is used for multicast data transmission.

Please note that if the shared tunnel is used, no interaction with UPF 110 is needed for the indicated MBS session.

Referring to FIG. 2B, optional steps S212a through S212e may be used for 5GC Individual MBS traffic delivery, if the related NG-RAN 105 does not support multicast. If a shared tunnel between the UPF (PDU Session Anchor (PSA)) 110 and MB-UPF 115 for 5GC individual MBS traffic delivery has not yet been established by the SMF 130 for the multicast session, steps S212a through 212e may be executed. Step 212f (not shown) is executed irrespective of that.

At step S212a, the SMF 130 may contact the UPF 110 to request the creation of a tunnel and provides the MBS session ID. The UPF 110 may indicate to the SMF 130 whether the tunnel for this MBS session is newly allocated (as there can be multiple SMFs interacting with the same UPF 110 for the same MBS Session). If the UPF 110 determines to use unicast transport over N19mb, the UPF 110 may allocate a DL N19mb Tunnel endpoint for the MBS session if the SMF request is the first one to allocate DL N19mb Tunnel endpoint for the MBS Session in the UPF 110. The UPF 110 may include the DL Tunnel Info in the response to the SMF 130. The DL tunnel info may include the downlink tunnel ID and the UPF address. The UPF 110 may now be ready for receiving the MBS data from the MB-UPF 135 and forwarding the data to the PDU session.

At step S212b, if the UPF 110 indicates the DL N19mb Tunnel is newly allocated, the SMF 130 may invoke Nmbsmf_MBSsession_ContextUpdate request (MBS Session ID, [DL tunnel info]) towards MB-SMF 135 that includes MBS Session ID and downlink tunnel info of UPF 110, for establishing the multicast session transport between MB-UPF 115 and UPF 110.

At step S212c, if the DL tunnel info of the UPF 110 is received, MB-SMF 135 may configure MB-UPF 115 to transmit the multicast session data towards UPF 110 using the possibly received downlink tunnel ID.

At step S212d, MB-SMF 135 may respond to SMF 130 through Nmbsmf_MBSSession_ContextUpdate response (MBS Session ID, [multicast DL tunnel info]). If the UPF DL tunnel info for unicast transport is not received by the MB-SMF 135, multicast transport between MB-UPF 115 and UPF 110 may be used, and the SMF 130 may include the downlink tunnel information with the transport multicast address for the multicast session.

At step S212e, for multicast transport between MB-UPF 115 and UPF 110, SMF 130 may configure UPF 110 to receive the multicast session data. If multicast transport over N19mb is used, the UPF 110 may join the source specific multicast group of MB-UPF 115. The UPF 110 may forward the data to the PDU session.

At step S212f (not shown), the MB-SMF 135 may configure the MB-UPF 115 to forward the received multicast session data within the PDU session. (This step may be combined with step S212a or S212e).

At step S213, the SMF 130 may invoke Nsmf_PDUSession_UpdateSMContext response to the AMF 125.

At step S214, the MB-UPF 115 may receive multicast PDUs, either directly from the content provider or via the MBSTF 120 that can manipulate the data.

Steps S215 to S217 are for 5GC shared MBS traffic delivery:

At step S215, MB-UPF 115 may send multicast PDUs in the N3mb tunnel associated to the multicast session to the NG-RAN 105. There is only one tunnel per multicast session and NG-RAN node 105, i.e., all the UEs which have joined the multicast session via the NG-RAN node 105 share this tunnel for reception of the multicast session data.

At an optional step S216, the NG-RAN 105 may select PTM or PTP radio bearers to deliver the multicast PDUs to the UE(s) 100 that have joined the multicast session.

At step S217, the NG-RAN 105 may transmit the multicast session data to the UE(s) 100 using the selected PTM or PTP radio bearer(s).

Steps S218 to S220 are for 5GC individual MBS traffic delivery:

At step S218, MB-UPF 115 may send multicast PDUs in the N19mb tunnel associated to the multicast session to UPF 110. There is only one tunnel per multicast session and destination UPF, i.e., all associated PDU sessions share this tunnel.

At step S219, UPF 110 may forward the multicast data towards the NG-RAN 105 via unicast (i.e. in the N3 tunnel of the associated PDU Session).

At step S220, the NG-RAN 105 may forward the multicast session data to the UE 100 via unicast (i.e. over the radio bearer(s) corresponding to the mapped unicast Qos flow(s) of the associated PDU Session).

Please note that when the MBSF 140 is involved in the multicast MBS session, the tunnel between MBSTF 120 and MB-UPF 115 has been established in the configuration procedure.

3GPP TS 23.247 Clause 7.2.2.3 describes Multicast session leave or session release requested by the network. The procedure applies for the scenario that 1) When the SMF decides to remove a UE from an MBS session, 2) When the MB-SMF decides to release an MBS Session:
based on a request from the AF (directly or via the NEF/MBSF); or
based on local policy (e.g., for load rebalancing).

When the SMF receives the notification indicating multicast session release from the MB-SMF, the SMF may initiate procedures to remove the joined UEs from the MBS session.

In S2-2109343, it is also agreed that for local MBS: Depending on policy, for the multicast MBS service the network may remove UEs outside the MBS service area of the MBS session from the MBS session context after a grace period.

Based on above, there are two scenarios to “remove UE from MBS session”:
session release: all the UEs are removed from the MBS session, and UEs shall not try to join the MBS session till the MBS session is created again.
Remove UE: due to certain condition, the network may remove the UE from the MBS session (e.g., the UE moves out of the MBS service area for a certain period). UE may join the MBS session again (e.g., the UE moves in the MBS service area).

In Clause 9.11.4.31 of TS 24.501 V17.4.1, the MBS decision (MD) is defined as follows:

MBS decision (MD) (bits 1 and 2 of octet 3)
The MD indicates the network decision of the join requested by the
UE or if the network requests to remove the UE from the MBS session.

Bits

| 2 | 1 | |
|---|---|---|
| 0 | 1 | MBS join is accepted |
| 1 | 0 | MBS join is rejected |
| 1 | 1 | Remove UE from MBS session |

All other values are reserved.

The “Remove UE from MBS session” applies for the Multicast session release scenario.

However, there is no MBS decision (MD) dedicated for Multicast session release in current 3GPP TS 23.247 and 3GPP TS 24.501. When a multicast session is released in network, UE is required to be removed from the MBS session. However, UE is not aware of the multicast session release, and it may request to join the release MBS session again which will be rejected by the network.

Therefore, some embodiments of the present disclosure propose a solution for the network to notify the UE about the multicast session release to avoid UE requesting to join the released multicast session, such that the unnecessary signaling between the UE and the network may be avoided. For the network this may reduce signaling load by avoiding unsuccessful requests from potentially large numbers of UEs. For the UE, avoiding unsuccessful requests will reduce resource usage, e.g., battery capacity.

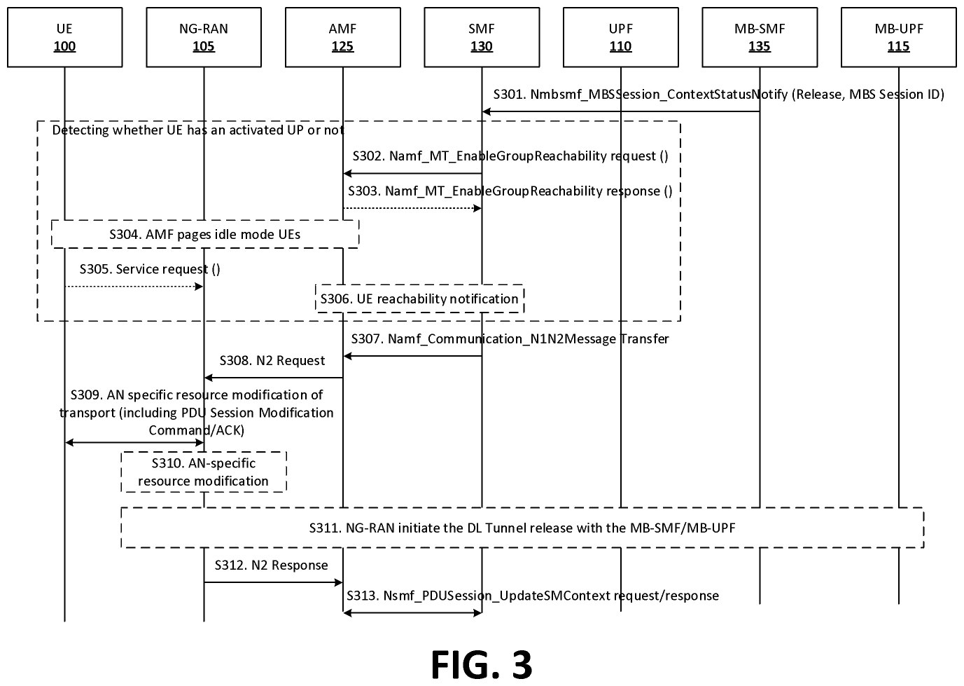

FIG. 3 is a diagram illustrating another exemplary procedure for managing a multicast session according to an embodiment of the present disclosure. Although multiple steps S301 through S313 are shown by FIG. 3, the present disclosure is not limited thereto. In some other embodiments, the procedure may comprise more operations, less operations, different operations, or any combination thereof. Further the operations of the procedure may be performed in a different order than that described herein. Further, in some embodiments, an operation in the procedure may be split into multiple sub-operations and performed by different entities, and/or multiple operations in the procedure may be combined into a single operation.

In some embodiments, this procedure may apply:
1. When the AF 150 determines to release the MBS Session, the AF 150 initiates MBS Session Release procedure towards the MB-SMF 135; and/or
2. When the SMF 130 decides to remove a UE from an MBS session, in which case, step S301 may be optional.

When the SMF 130 receives the notification indicating multicast session release from the MB-SMF 135, the SMF 130 may initiate procedures to remove the joined UEs from the MBS session.

For the active MBS session, to release radio resources as early as possible, the MB-SMF 135 may trigger Multicast Session Deactivation towards the NG-RAN 105 as specified in clause 7.2.5.3 of TS 23.247, prior to or in parallel with triggering MBS Session Release to the SMF 130.

As shown in FIG. 3, at step S301, the SMF 130 may receive Nmbsmf_MBSSession_ContextStatusNotify (Release, MBS Session ID) from the MB-SMF 135 with MBS Session ID. The SMF 130 may check joined UEs (e.g., the UE 100).

For UEs without activated UP, the SMF 130 may perform the steps S302 through S306, by which the SMF 130 may detect or otherwise determine whether UE has an activated UP or not.

At step S302, SMF 130 may send Namf_MT_EnableGroupReachability Request to AMF 125, including (UE list, TMGI, associated information). When later UE is reachable, the associated information may be used by the AMF 125 to identify and notify the related SMF 130 to activate the associated PDU Session.

At step S303, if the UE involved in the MBS Session is in CM-CONNECTED state, the AMF 125 may respond the list of the UE involved in the MBS Session and in CM-CONNECTED state, using Namf_MT_EnableGroupReachability Response (UE list). Steps S304 through S305 will not be executed for the UEs in the list.

At step S304, if AMF 125 determines that there are any UEs in CM-IDLE state and involved in the MBS Session, and AMF 125 figures out the paging area considering all the UE(s), which need be paged. The AMF 125 may send a paging request message to the NG-RAN node(s) 105 belonging to this Paging Area with the TMGI as the identifier to be paged if the related NG-RAN node(s) 105 support the MBS session. If the NG-RAN node(s) 105 does not support MBS, the AMF 125 may send Paging message to the NG-RAN node(s) 105 per UE without using the MBS Session ID as described in step 4b in clause 4.2.3.3 of TS 23.502.

At step S305, the UE(s) 100 in CM-IDLE state may send Service Request message to AMF 125, see clause 4.2.3 of TS 23.502.

At step S306, after receiving the Service Request sent by the UE(s) 100, based on the received associated information in step S302 the AMF 125 may identify and notify the related SMF 130 of the UE(s) 100, which are reachable now.

Alternatively, for UEs without activated UP, the SMF 130 may not trigger message to the AMF 125, instead the SMF 130 may mark that the UE 100 is to be informed of the MBS Session release.

Please note that the SMF 130 may initiate PDU Session Modification to inform the UE 100 of the MBS Session release at next UP activation of the associated PDU Session.

At step S307, for the joined UEs 100 with UP activated, the SMF 130 may invoke Namf_Communicate_N1N2MessageTransfer to the AMF 125. The N1 SM container may indicate MBS session release. In N2 SM information, the SMF 130 may inform the NG-RAN 105 to remove the UE 100 from the MBS session. If there are associated Qos Flow(s) for individual delivery, the SMF 130 may also release those QoS Flow(s) as specified in clause 4.3.3.2 of TS 23.502.

Further, as mentioned above, in the case where the UE 100 is to be notified of the MBS session release, when the SMF 130 receives the notification indicating multicast session release from the MB-SMF 135, the SMF 130 may initiate procedures to remove the joined UEs (e.g., the UE 100) from the MBS session and notify the UE 100 about the MBS session release, for example, with a “received MBS container” in the N1 SM container in the Namf_Communicate_N1N2MessageTransfer message.

There may be multiple options to notify the UE 100 about the MBS session release:

Option #1: In a modified table 9.11.4.31.1 of 3GPP TS 24.501, a new MD about MBS Session release may be added as follows:

MBS decision (MD) (bits a to c of octet x)
The MD indicates the network decision of the join requested by the
UE or if the network requests to remove the UE from the MBS session.

| Bits | | | |
|---|---|---|---|
| c | b | a | |
| 0 | 0 | 1 | MBS join is accepted |
| 0 | 1 | 0 | MBS join is rejected |
| 0 | 1 | 1 | Remove UE from MBS session |
| 1 | 0 | 0 | MBS session has been released |

All other values are reserved.

Option 2: In a modified table 9.11.4.31.1, a differentiating reason for removing the UE 100 from the MBS session can be provided in the rejection cause provided with the MBS decision indication as follows:

Rejection cause (bits 6 to 8 of octet 3)
The Rejection cause indicates the reason of rejecting the join request.

| Bits | | | |
|---|---|---|---|
| 8 | 7 | 6 | |
| 0 | 0 | 0 | No additional information provided |
| 0 | 0 | 1 | Insufficient resources |
| 0 | 1 | 0 | User is not authorized to use MBS service |
| 0 | 1 | 1 | MBS session has not started or will not start soon |
| 1 | 0 | 0 | User is outside of local MBS service area |
| 1 | 0 | 1 | Session context not found |
| 1 | 1 | 0 | MBS session is released |

All other values are unused in this version of the specification and interpreted as 000 if received.

For both options, related requirements for the UE 100 need to be added in NAS procedures used to release the UE 100 from an MBS session, e.g., PDU session modification procedure, such that the UE 100 may be prevented from triggering MBS session join attempts if the MBS session is released.

Further, other options may be possible, for example, a combination of these two options or another new field in the “received MBS container”.

Further, an exemplary change request for the specification 3GPP TS 24.501 is provided at the end of the document as Appendix A, which also proposes a mechanism for the network to notify the UE of MBS session release.

Further, in the case where the UE 100 is not to be notified of the MBS session release, a same Namf_Communicate_N1N2MessageTransfer message as that used in 3GPP TS 23.247 Clause 7.2.2.3 may be used.

At step S308, the AMF 125 may send N2 Request to the NG-RAN 105.

At step S309, the NG-RAN 105 may transport the N1 SM container (PDU Session Modification Command) to the UE 100.

In some embodiments where the UE is to be notified of MBS session release, the NG-RAN 105 may transport the N1 SM container (PDU Session Modification Command (MBS Session ID, MBS session release)) to the UE, instead of N1 SM container (PDU Session Modification Command (MBS Session ID, leave request)) that may be used for embodiments where the UE is not to be notified of MBS session release.

At an optional step S310, the NG-RAN 105 may perform radio resource modification. If no joined UEs in the MBS session, the NG-RAN 105 may release the radio resources.

At an optional step S311, if no joined UEs in the MBS session, for unicast transport of N3mb, the NG-RAN 105 may initiate the DL tunnel release towards MB-UPF 115 via AMF 125 and MB-SMF 135. For multicast transportation of N3mb, the NG-RAN 105 may perform IGMP/MLD Leave for the MBS session.

At step S312, the NG-RAN 105 may send N2 Response to the AMF 125. If no joined UEs in the MBS session, the MBS Session context may be removed from the NG-RAN 105.

At step S313, the AMF 125 may transfer the N2 message received in step S312 to the SMF 130 via the Nsmf_PDUSession_UpdateSMContext service operation. The SMF 130 may remove the UE 100 from the MBS Session.

Further, when the UP for the associated PDU Session is activated as specified in clause 4.2.3.2 and clause 4.2.3.3 of TS 23.502, the SMF 130 may initiate PDU Session Modification to inform the UE 100 of the MBS Session release, if needed.

With this procedure, the UE 100 may be notified of the MBS session release, such that the UE 100 may be aware of that the MBS session is released by the network and no further attempt for rejoining the MBS session is needed and unnecessary signaling between the UE 100 and the network may be avoided.

FIG. 6 is a flow chart of an exemplary method 600 at an SMF for managing a multicast session for a UE according to an embodiment of the present disclosure. The method 600 may be performed at a first network node (e.g., the SMF 130 shown in FIG. 3). The method 600 may comprise steps S610 and S620. However, the present disclosure is not limited thereto. In some other embodiments, the method 600 may comprise more steps, less steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where a first message indicating that the multicast session is released may be received from an MB-SMF.

At step S620, a first indication indicating that the multicast session is released may be transmitted to the UE. In some embodiments, the first indication may comprise one or more bits for rejection cause which may indicate the reason of removing the UE from the multicast session.

In some embodiments, the method 600 may further comprise: deciding to remove the UE from the multicast session. In some embodiments, the first indication may comprise one or more bits indicating that the multicast session is released. In some embodiments, the one or more bits may comprise at least one of: one or more bits for MBS decision; one or more bits for rejection cause; and a combination thereof. In some embodiments, an operation code indicated by the one or more bits may be different from those specified in 3GPP TS 24.501 V17.4.1 or any preceding versions thereof. In some embodiments, a rejection cause indicated by the one or more bits may be different from those specified in 3GPP TS 24.501 V17.4.1 or any preceding versions thereof.

In some embodiments, the first indication may be transmitted to the UE via an AMF and a RAN node that serve the UE. In some embodiments, before the step S620, the method 600 may further comprise: determining whether the UE has an activated UP or not. In some embodiments, before the step S610, the method 600 may further comprise: transmitting, to the MB-SMF, a second message for subscribing a session context of the multicast session. In some embodiments, the method 600 may further comprise: receiving, from the AMF, a third message indicating that the UE is currently aware of the release of the multicast session. In some embodiments, at least one of following may be true: the first message may be an Nmbsmf_MBSSession_ContextStatusNotify message; the second message may be an Nmbsmf_MBSSession_ContextStatusSubscribe request message; and the third message may be an Nsmf_PDUSession_UpdateSMContext request message; and the first indication may be an N1 Session Management (SM) container that is carried by an Namf_Communication_N1N2MessageTransfer message from the SMF to the AMF, by an N2 Request message from the AMF to the RAN node, and by a Protocol Data Unit (PDU) Session Modification Command encapsulated in a Radio Resource Control (RRC) message from the RAN node to the UE.

FIG. 7 is a flow chart of an exemplary method 700 at a UE for managing a multicast session according to an embodiment of the present disclosure. The method 700 may be performed at a UE (e.g., the UE 100 shown in FIG. 3). The method 700 may comprise a step S710. However, the present disclosure is not limited thereto. In some other embodiments, the method 700 may comprise more steps, different steps, or any combination thereof. Further the steps of the method 700 may be performed in a different order than that described herein. Further, in some embodiments, a step in the method 700 may be split into multiple sub-steps and performed by different entities, and/or multiple steps in the method 700 may be combined into a single step.

The method 700 may begin at step S710 where a first indication indicating that the multicast session is released may be received from an SMF. In some embodiments, the first indication may comprise one or more bits for rejection cause which may indicate the reason of removing the UE from the multicast session.

In some embodiments, the first indication may comprise one or more bits indicating that the multicast session is released. In some embodiments, the one or more bits may comprise at least one of: one or more bits for MBS decision; one or more bits for rejection cause; and a combination thereof. In some embodiments, an operation code indicated by the one or more bits may be different from those specified in 3GPP TS 24.501 V17.4.1 or any preceding versions thereof. In some embodiments, a rejection cause indicated by the one or more bits may be different from those specified in 3GPP TS 24.501 V17.4.1 or any preceding versions thereof. In some embodiments, the first indication may be received from the SMF via an AMF and a RAN node that serve the UE. In some embodiments, the method 700 may further comprise: transmitting, to the RAN node, a fourth message indicating that the UE is currently aware of the release of the multicast session. In some embodiments, at least one of following may be true: the fourth message may be a PDU Session Modification Acknowledgement message; and the first indication may be an N1 Session Management (SM) container that is carried by an Namf_Communication_N1N2MessageTransfer message from the SMF to the AMF, by an N2 Request message from the AMF to the RAN node, and by a PDU Session Modification Command encapsulated in an RRC message from the RAN node to the UE.

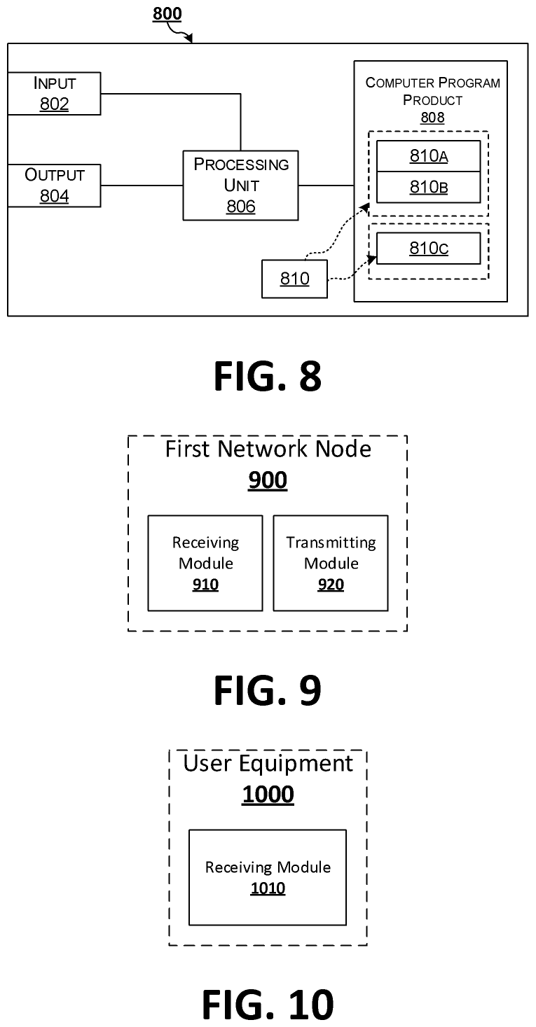

FIG. 8 schematically shows an embodiment of an arrangement which may be used in a network node and/or a UE according to an embodiment of the present disclosure. Comprised in the arrangement 800 are a processing unit 806, e.g., with a Digital Signal Processor (DSP) or a Central Processing Unit (CPU). The processing unit 806 may be a single unit or a plurality of units to perform different actions of procedures described herein. The arrangement 800 may also comprise an input unit 802 for receiving signals from other entities, and an output unit 804 for providing signal(s) to other entities. The input unit 802 and the output unit 804 may be arranged as an integrated entity or as separate entities.

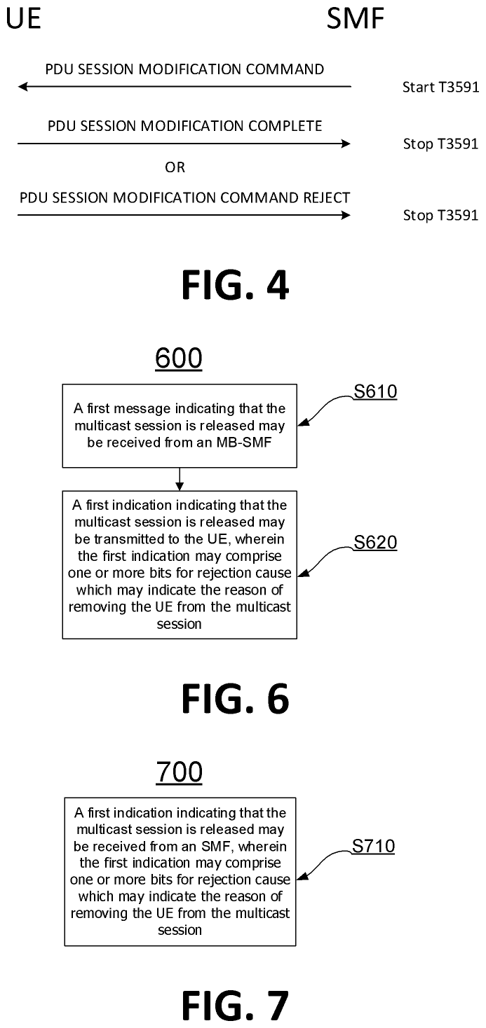

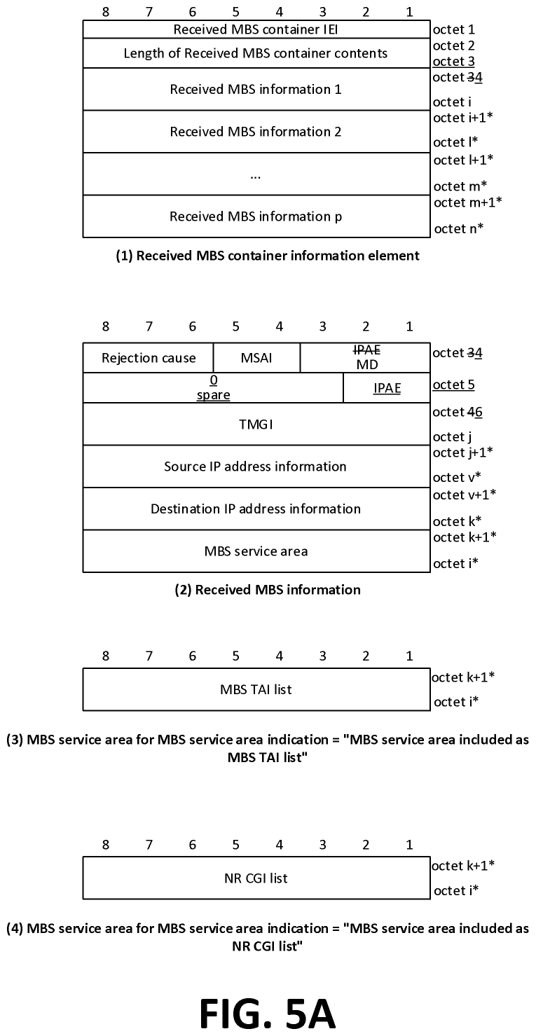

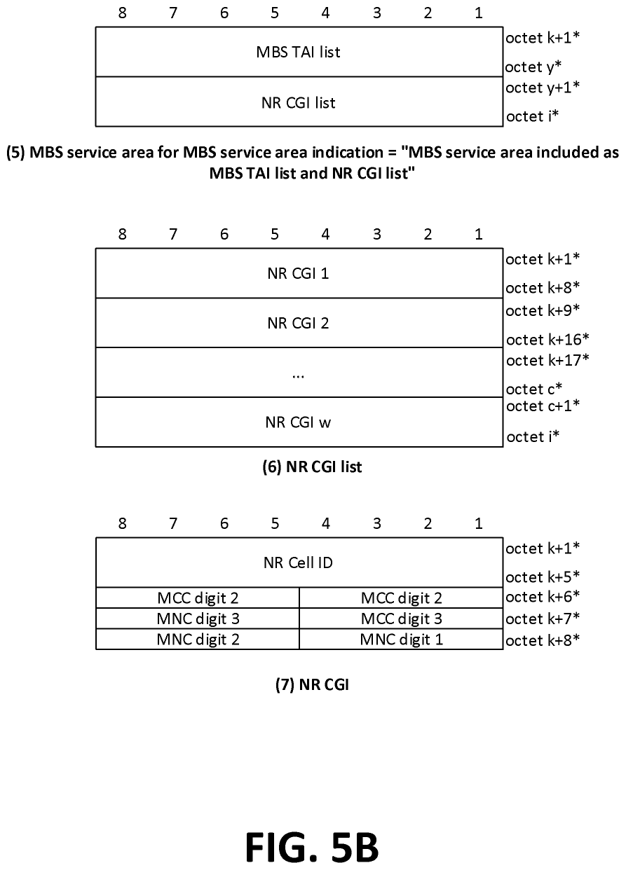

Furthermore, the arrangement 800 may comprise at least one computer program product 808 in the form of a non-volatile or volatile memory, e.g., an Electrically Erasable Programmable Read-Only Memory (EEPROM), a flash memory and/or a hard drive. The computer program product 808 comprises a computer program 810, which comprises code/computer readable instructions, which when executed by the processing unit 806 in the arrangement 800 causes the arrangement 800 and/or the first network node and/or the UE in which it is comprised to perform the actions, e.g., of the procedure described earlier in conjunction with FIG. 2A through FIG. 7 or any other variant.

The computer program 810 may be configured as a computer program code structured in computer program modules 810A-810B. Hence, in an exemplifying embodiment when the arrangement 800 is used in a first network node, the code in the computer program of the arrangement 800 includes: a module 810A for receiving, from an MB-SMF, a first message indicating that the multicast session is released; and a module 810B for transmitting, to the UE, a first indication indicating that the multicast session is released.

The computer program 810 may be further configured as a computer program code structured in a computer program module 810C. Hence, in an exemplifying embodiment when the arrangement 800 is used in a UE, the code in the computer program of the arrangement 800 includes: a module 810C for receiving, from an SMF, a first indication indicating that the multicast session is released.

The computer program modules could essentially perform the actions of the flow illustrated in FIG. 2A through FIG. 7, to emulate the first network node and/or the UE. In other words, when the different computer program modules are executed in the processing unit 806, they may correspond to different modules in the first network node and/or the UE.

Although the code means in the embodiments disclosed above in conjunction with FIG. 8 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the first network node.

Correspondingly to the method 600 as described above, an exemplary first network node is provided. FIG. 9 is a block diagram of a first network node 900 according to an embodiment of the present disclosure. The first network node 900 may be, e.g., the SMF 130 in some embodiments.

The first network node 900 may be configured to perform the method 600 as described above in connection with FIG. 6. As shown in FIG. 9, the first network node 900 may comprise a receiving module 910 configured to receive, from an MB-SMF, a first message indicating that the multicast session is released; and a transmitting module 920 configured to transmit, to the UE, a first indication indicating that the multicast session is released.

The above modules 910 and/or 920 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the first network node 900 may comprise one or more further modules, each of which may perform any of the steps of the method 600 described with reference to FIG. 6.

Correspondingly to the method 700 as described above, an exemplary user equipment is provided. FIG. 10 is a block diagram of a UE 1000 according to an embodiment of the present disclosure. The UE 1000 may be, e.g., the UE 100 in some embodiments.

The UE 1000 may be configured to perform the method 700 as described above in connection with FIG. 7. As shown in FIG. 10, the UE 1000 may comprise a receiving module 1010 for receiving, from an SMF, a first indication indicating that the multicast session is released.

The above module 1010 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the UE 1000 may comprise one or more further modules, each of which may perform any of the steps of the method 700 described with reference to FIG. 7.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| AMF | Access and Mobility Management Function |
| MBS | Multicast/Broadcast Service |
| MB-SMF | Multicast/Broadcast Session Management Function |
| SMF | Session Management Function |

1. A method at a Session Management Function (SMF) for managing a multicast session for one or more User Equipments (UEs), the method comprising:
receiving, from a Multicast/Broadcast Session Management Function (MB-SMF), a first message indicating that the multicast session is released; and
transmitting, to the one or more UEs, a first indication indicating that the multicast session is released, wherein the first indication comprises one or more bits for rejection cause which indicates the reason of removing the one or more UEs from the multicast session.

2. The method of claim 1, further comprising:
prior to transmitting to the one or more UEs, determining to remove the one or more UEs that have joined the multicast session from the multicast session.

3. The method of claim 1, wherein the first indication is transmitted to the one or more UEs via an Access and Mobility management Function (AMF) and a Radio Access Network (RAN) node that serve the one or more UEs.

4. The method of claim 1, wherein transmitting, to the one or more UEs, the first indication further comprises transmitting the first indication to the one or more
UEs that have joined the multicast session and have an activated User Plane (UP).

5. The method of claim 1, wherein before receiving, from the MB-SMF, the first message, the method further comprises:
transmitting, to the MB-SMF, a second message for subscribing a session context of the multicast session.

6. The method of claim 3, further comprising:
receiving, from the AMF, a third message indicating that the one or more UEs are currently aware of the release of the multicast session.

7. The method of claim 1, wherein at least one of following is true:
the first message is an Nmbsmf_MBSSession_ContextStatusNotify message;
the second message is an Nmbsmf_MBSSession_ContextStatusSubscribe request message; and
the third message is an Nsmf_PDUSession_UpdateSMContext request message; and
the first indication is an N1 Session Management (SM) container that is carried by an Namf_Communication_NIN2MessageTransfer message from the SMF to the AMF, by an N2 Request message from the AMF to the RAN node, and by a Protocol Data Unit (PDU) Session Modification Command encapsulated in a Radio Resource Control (RRC) message from the RAN node to the one or more UEs.

8-9. (canceled)

10. A method at a UE for managing a multicast session, the method comprising:
receiving, from an SMF, a first indication indicating that the multicast session is released, wherein the first indication comprises one or more bits for rejection cause which indicates the reason of removing the UE from the multicast session.

11. The method of claim 10, wherein the first indication is received from the SMF via an AMF and a RAN node that serve the UE.

12. The method of claim 11, further comprising:
transmitting, to the RAN node, a fourth message indicating that the UE is currently aware of the release of the multicast session.

13. The method of claim 10, wherein at least one of following is true:
the fourth message is a PDU Session Modification Acknowledgement message; and
the first indication is an N1 SM container that is carried by an Namf_Communication_NIN2MessageTransfer message from the SMF to the AMF, by an N2 Request message from the AMF to the RAN node, and by a PDU Session Modification Command encapsulated in an RRC message from the RAN node to the UE.

14. A UE, comprising:
a processor;
a memory storing instructions which, when executed by the processor, cause the processor to receive, from an SMF, a first indication indicating that the multicast session is released, wherein the first indication comprises one or more bits for rejection cause which indicates the reason of removing the UE from the multicast session.

15-17. (canceled)
